(19) United States
(12) Patent Application Publication
(10) Pub. No.: US 2009/0106030 A1
(43) Pub. Date: Apr. 23, 2009

(54) METHOD OF SIGNAL ENCODING

(75) Inventors: Albertus Cornelis Den Brinker, Eindhoven (NL); Felipe Riera Palou, Palma de Mallorca (ES)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,613

(22) PCT Filed: Nov. 2, 2005
(86) PCT No.: PCT/IB2005/053580

§ 371 Date: May 4, 2007

(30) Foreign Application Priority Data
Nov. 9, 2004 (EP) 04105624.3

(51) Int. Cl. G10L 19/00

(52) U.S. Cl. 704/500

(57) ABSTRACT

There is described a method of encoding a signal (s(n)) in a coder (400) to generate a corresponding encoded bit-stream (x(n); STP). The method comprises steps of: (a) processing the signal (s(n)) to determine main sinusoidal components and transient components thereof to generate corresponding component parameters; (b) processing the signal (s(n)) by removing the sinusoidal and transient components therefrom to generate a residual signal (r(n)); (c) processing the residual signal (r(n)) to determine a spectral representation (PSD) and determining therefrom a spectral broadening measure (SBM); (d) determining from the residual signal (r(n)) spectral envelope parameters by linear prediction; and (e) combining the components parameters together with the spectral envelope parameters and the spectral broadening measure to generate the encoded bit-stream. The method is capable of reducing noise that would otherwise arise were the bitstream to be decoded not subjected to such spectral broadening.

The present invention relates to methods of signal encoding, for example to methods of signal encoding using parametric and hybrid parametric/waveform coders. Moreover, the invention also relates to apparatus operable to execute such methods of signal encoding.

Predictive coding methods are known, for example as described in a published scientific paper “Predictive Coding of Speech Signals and Subjective Error Criteria” by Atal and Schroeder, IEEE Transactions on Acoustics, Speech, and Signal Processing, Vol. ASSP-27. no. 3, June 1979. In this paper, it is disclosed that predictive coding methods attempt to reduce r.m.s. (root mean square) errors arising in coded signals. However, it has been found in practice that the human ear does not perceive signal distortion on the basis of r.m.s. error, regardless of its spectral shape relative to a spectrum of a signal encoded. It is known from contemporary theories of audio masking that noise present in formant regions of spoken speech is at least partially masked by the speech signal itself. In consequence, a large proportion of perceived noise arising in a speech coder derives from frequency regions where the signal level is relatively low. In the publication, it is proposed that improved reproduced speech quality can be obtained by a combination of efficient removal of formant and pitch-related redundant structure of speech signal before applying quantization thereto, and by effective masking of quantizer noise by the speech signal. In particular, there is described in this publication that reduction in quantizer noise when processing speech signals at one frequency can be obtained only at the expense of increasing the quantizer noise at another frequency; since a large proportion of perceived noise in a coder derives from frequency regions where the signal level is relatively low, a filter can be applied to reduce the noise in such regions whilst increasing noise in the formant regions where the noise is potentially susceptible to being effectively masked by the speech signal. A common way of achieving an appropriate spectral shape for such quantisation noise, and thus a best error concealment, is to use so-called spectral broadening factors usually denoted by a symbol γ. The factors γ are applicable for adapting a given transfer function from F(z) to F(z/γ). Moreover, the factors are contemporarily maintained constant.

An object of the present invention is to provide a method of signal encoding which at least partially addresses excess noise problems which are susceptible to arising during noise decoding.

According to a first aspect of the present invention, there is provided a method of encoding a signal (s(n)) in a coder to generate a corresponding encoded bit-stream (x(n); STP), said method comprising steps of:

(a) processing the signal (s(n)) to determine main sinusoidal components and transient components thereof to generate corresponding component parameters (SiP, TrP);
(b) processing the signal (s(n)) by removing the determined sinusoidal and transient components therefrom to generate a residual signal (r(n));
(c) processing the residual signal (r(n)) to determine a spectral representation (PSD) and determining therefrom a spectral broadening measure;
(d) determining from the residual signal (r(n)) spectral envelope parameters by linear prediction; and
(e) combining the component parameters (SiP, TrP) together with the spectral envelope parameters and the spectral broadening measure to generate the encoded bit-stream.

The invention is of advantage in that the spectral broadening is capable of reducing subsequent decoder noise problems arising from prominent tones encountered in the residual signal.

The inventors have appreciated that:

(a) the spectral broadening applied in speech coding for noise concealment can surprisingly also be used in noise encoding within parametric audio coding, for example of music signals;
(b) spectral broadening factors employed should be signal dependent; and
(c) a simple mechanism for adjusting such factors to the signal is feasible.

Optionally, the spectral envelope parameters and the spectral broadening measure (SBM) can be included in the bit-stream separately, for example in mutually different data fields thereof. Alternatively, the spectral envelope parameters and the spectral broadening measure (SBM) can be combined in the bit-stream, for example to provide the bit-stream with a simpler data structure.

Optionally, in the method, the spectral broadening measure (SBM) determined in step (c) is operable to at least reduce excess noise that would otherwise arise if the spectral broadening measure were not included in the encoded bit-stream.

Optionally, in the method, the spectral broadening measure is determined from the residual signal (r(n)) on a frame-by-frame basis.

Optionally, in the method, the spectral broadening measure (SBM) is determined in response to how many prominent tones are identified in the residual signal (r(n)). Surprisingly, the inventors have identified that a simple “rule of thumb” approach can be applied for determining degree of spectral broadening to be applied, such “rule of thumb” thereby rendering the method computationally easier to implement.

More optionally, in the method, relatively mild spectral broadening is applied when the number of prominent tones identified in the residual signal (r(n)) is less than a predetermined threshold, and relatively severe spectral broadening is applied when the number of prominent tones identified in the residual signal (r(n)) is equal to or greater than said predetermined threshold. Use of such a threshold for determining spectral broadening to be applied is susceptible to simplifying computational complexity when implementing the method in practice. Most preferably, the predetermined threshold corresponds to three prominent tones.

Optionally, in the method, said one or more prominent tones are determined by applying a Bark scale. The Bark scale has been found by the inventors to be an efficient and reliable approach to prominent tones without involving excess computation. More optionally, in the method, the Bark scale is applied to identify a prominent tone when its spectral representation (for example, the spectrum or power spectral density) contains a component with amplitude exceeding those within a neighbourhood thereto by more than a threshold. Most optionally, in the method, the threshold is in a range of 5 to 15 dB, more preferably substantially 7 dB.

A convenient spectral broadening measure is the spectral broadening factory. The factor γ ranges from 1 to 0 corresponding to no spectral broadening and complete spectral broadening (namely spectral flattening) respectively. When determining an appropriate degree of spectral broadening measure (SBM), the inventors have appreciated that other analysis results derived from the input signal (s(n)) can be used. Optionally, the method comprises steps of filtering the residual signal (r(n)) into a plurality of frequency bands, and determining said spectral broadening measure (SBM) in response to relative mean spectral power representation (for example, amplitude spectrum or power density) of said plurality of frequency bands. The use of frequency bands is useful for determining whether the spectrum of the residual signal (r(n)) is ascending or descending with frequency and therefrom determining a suitable spectral broadening measure.

Thus, optionally, in the method, the spectral broadening measure in step (c) approaches a value of unity in response to the relative mean amplitude spectrum or spectral power density of said plurality of frequency bands decaying with increasing frequency. Conversely, in the method, the spectral broadening measure in step (c) preferably departs significantly from a unity value in response to the relative mean spectral power density of said plurality of frequency bands increasing with increasing frequency.

According to a second aspect of the invention, there is provided a coder for encoding an input signal (s(n)) to generate a corresponding encoded bit-stream, said coder being operable according to a method of the first aspect of the invention.

According to a third aspect of the present invention, there is provided a decoder operable to decode an encoded bit-stream generated according to a method of the first aspect of the invention where the bit-stream includes the spectral broadening measure (SBM) explicitly.

According to a fourth aspect of the present invention, there is provided a signal processing system comprising:

(a) a coder according to the second aspect of the invention for coding an input signal (s(n)) to generate a corresponding encoded bit-stream; and
(b) a decoder according to the third aspect of the invention for receiving the encoded bit-stream and decoding said bit-stream to regenerate a representation of said input signal (s(n)).

According to a fifth aspect of the present invention, there is provided encoded data comprising an encoded bit-stream generated according to a method of the first aspect of the invention explicitly including the spectral broadening measure. Optionally, the encoded data is recorded on a data carrier.

It will be appreciated that features of the invention are susceptible to being combined in any combination without departing from the scope of the invention.

Embodiments of the invention will now be described, by way of example only, with reference to the following diagrams wherein:

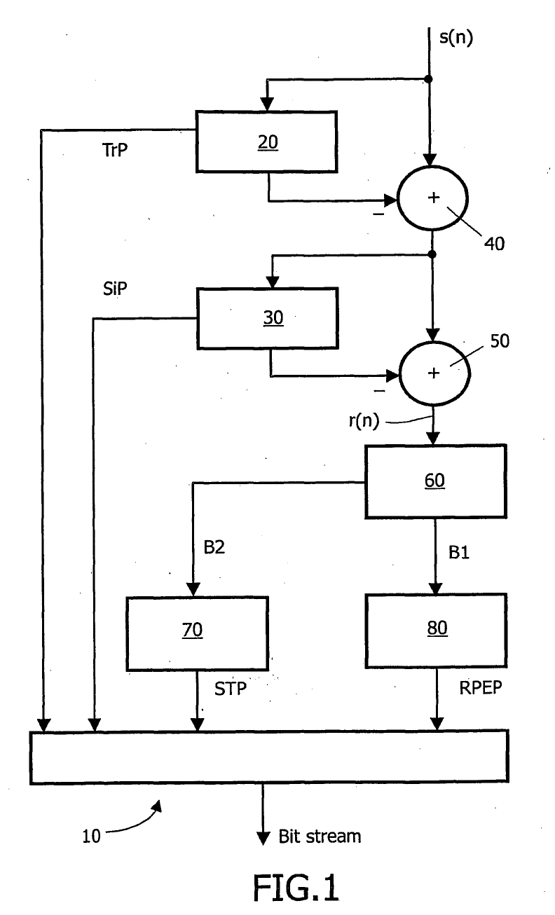

FIG. 1 is a schematic illustration of a coder architecture based on complementing MPEG-4 SSC noise coding based on RPE;

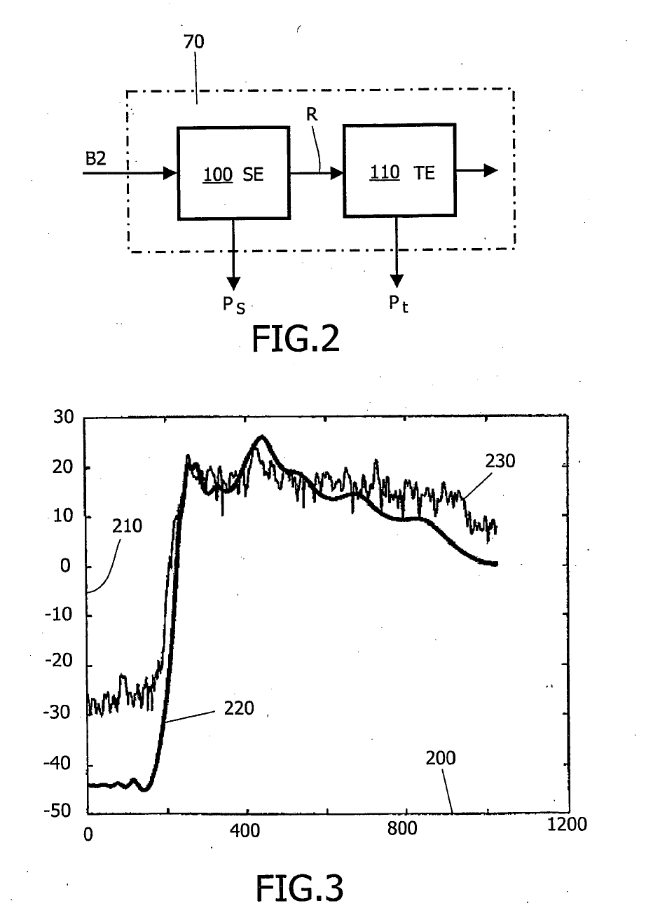

FIG. 2 is a schematic diagram of a noise processor operable as a noise coder of the coder whose architecture is illustrated in FIG. 1;

FIG. 3 is a graph of a spectrum of a signal B2 and its estimated spectral envelope without spectral broadening applied;

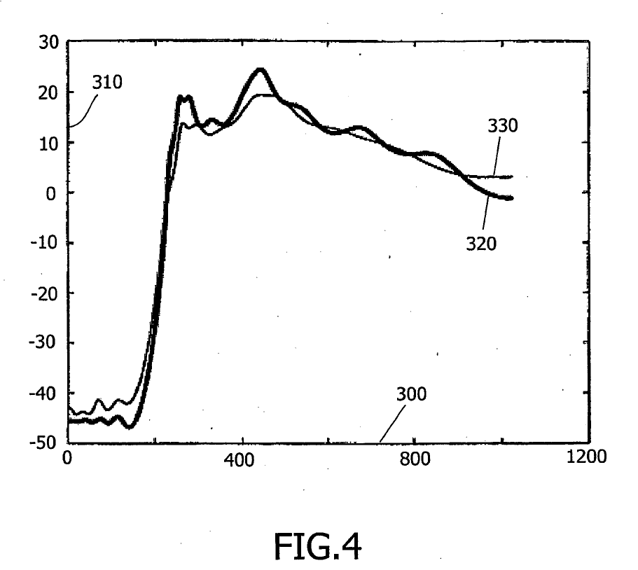

FIG. 4 is an illustration of spectral broadening as employed in the present invention applied to the estimated spectral envelope of FIG. 3;

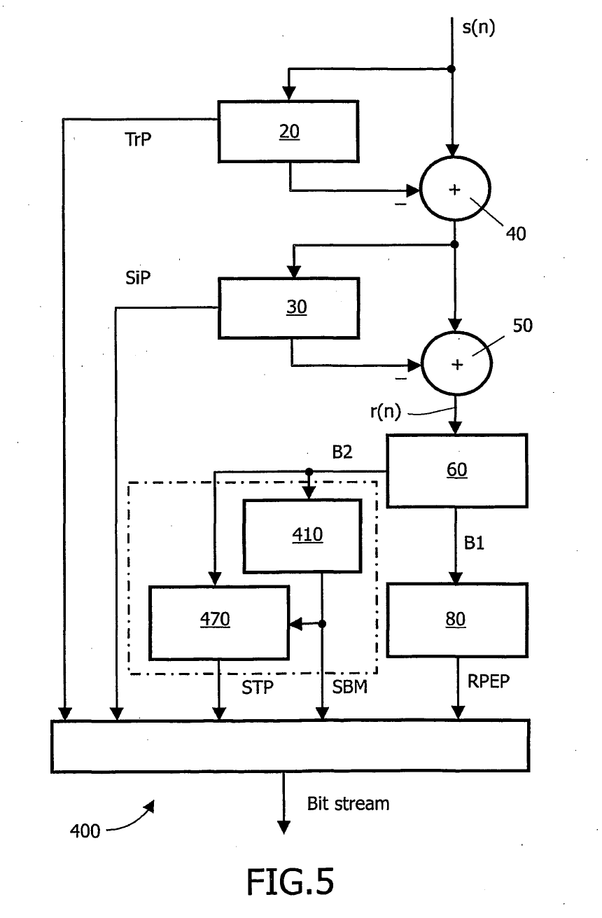

FIG. 5 is an illustration of an embodiment of the present invention in the form of a coder;

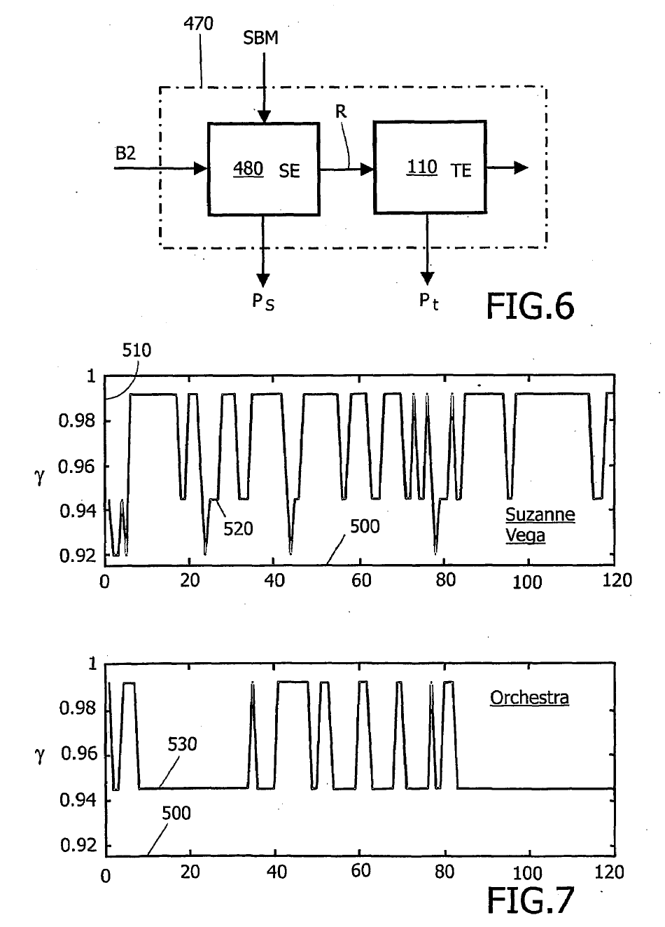

FIG. 6 is an illustration of a noise encoder according to the present invention; and

FIG. 7 is an example of a determined spectral broadening factor for two different audio signals processed by the coder of FIG. 5.

The inventors have appreciated that a combination of parametric and waveform coding can be employed to provide a scalable coder. The parametric coding is preferably implemented as a sinusoidal coder (SSC), for example as in a contemporary standard MPEG-4 (MPEG-4 SSC) whereas the waveform coding is preferably implemented as a coder based on regular pulse excitation (RPE). Such a hybrid arrangement for the scalable coder is capable of operating in practice over a wide range of output bit rates and exhibiting, at every output bit rate, a comparable coding quality to contemporary state-of-the-art coders.

The inventors have further appreciated that it is feasible to apply waveform processing techniques as a part of a noise coding process of SSC. In contemporary MPEG-4 SSC coders, sinusoidal and transient signal analysis stages are employed. Signals output from such stages is known as an SSC residual which is susceptible to being coded parametrically in the form of spectral and temporal envelope coefficients; such a process is usually referred to as “noise coding”. At a subsequent compatible decoder, these parameters are used to appropriately shape locally-generated white noise. Such parametric representation provides extremely efficient coding from a bit-rate aspect, although it is often insufficiently adapted for capturing characteristics of the SSC residual so as to render such coders for use in encoding high quality audio signals.

The inventors have considered using aforementioned RPE to complement contemporary MPEG-4 SSC noise coding in a coder whose architecture is illustrated schematically in FIG. 1. The coder is indicated generally by 10 and is operable to encode an input signal s(n) and to generate a bit-stream comprising parametric data; the parametric data includes transient parameters (TrP), sinusoidal parameters (SiP) and associated noise modelling parameters (STP, RPEP). STP is an abbreviation for “spectral and temporal parameters”, and RPEP is an abbreviation for “RPE parameters”.

The coder 10 comprises a transient analyzer (TrA) 20 and a sinusoidal signal analyzer (SSA) 30 coupled as illustrated to first and second summing units 40, 50 respectively. The transient analyzer (TrA) 20 and the sinusoidal analyzer (SSA) 30 are operable to generate the transient parameters TrP and the sinusoidal parameters SiP. An output signal r(n) from the second summing unit 50 is input to a signal band splitting filter (BDF) 60 including first and second outputs B1, B2 for splitting components of the signal into a first 0 to 5.5 kHz group and a second 5.5 to 22 kHz group respectively. These outputs B1, B2 are coupled to a regular pulse excitation unit (RPE) 80 and a noise processor (NC) 70 respectively for generating the aforementioned associated parameters STP and RPEP respectively.

In operation of the coder 10, the signal r(n) from preceding sinusoidal and transient analysis stages, the signal r(n) being an SSC residual, is coded parametrically in the form of spectral and temporal envelope coefficients. The filter 60 divides the signal r(n) into low frequency components for the RPE unit 80 and high frequency components for the noise processor 70. The RPE unit 80 is employed for the low frequency components because human hearing is most sensitive at these low frequencies, whereas conventional noise modelling is applied to code high frequency components in a manner akin to that employed in MPEG-4 SSC. Conveniently, operation of the coder 10 is referred to as “RPE/noise coding of the SSC residual” and the coder 10 is referred to as a “SSC-RPE coder”. Initial experiments executed by the inventors has demonstrated that the coder 10 represents a considerable improvement in coding quality in comparison to contemporary known coding schemes such as MPEG-4 SSC. However, the coder 10 exhibits a drawback in that its output bit-rate is increased by 2-3 kbytes/second in comparison to MPEG-4 SSC. When coding audio signals, the coder 10 generates output data at the x(n) and STP outputs at a total bit-rate in a range of 26 to 27 kbytes/second. A normal output bit-rate for contemporary MPEG-4 SSC coding is substantially in a range of 17 to 18 kbytes/second for sinusoidal and transient components (TrP, SiP) together with noise modelling parameters (STP) requiring a bit-rate in a range of 6 to 7 kbytes/second for coding SSC residual components.

An aim of the proposed coder is to operate at a similar bit rate in comparison to a corresponding contemporary MPEG-4 SSC coder but with a high audio quality. In the coder 10, the use of RPE for the output B1, RPE/noise encoding within the coder 10 requires in a range of 9 to 10 kbytes/second of which 6 kbytes/second are needed for RPE coding of low frequency bands and 3 to 4 kbytes/second are needed for encoding corresponding higher frequency bands. The inventors have appreciated for the coder 10 that sinusoidal signal components processed therein are better able to withstand bit-rate reductions in comparison to RPE-noise components. Consequently, the inventors have been able to adapt the coder 10 to provide an encoder in which processing of sinusoidal signal components gives rise to an output bit-rate of 15 kbytes/second which is susceptible to being combined with an output bit-rate of 9 kbytes/second for RPE-noise components to yield and total output bit-rate of 24 kbytes/second which is comparable to contemporary MPEG-4 SSC encoders.

Such a reduction in bit-rate in the coder 10 results in a problem that the SSC residual r(n) to be RPE/Noise coded includes a relative large number of tonal components in comparison to SSC residuals of contemporary MPEG-4 SSC coders. In the coder 10, extra low-frequency sinusoidal components are normally compensated for in the RPE unit 80. However, high-frequency sinusoidal components normally processed in the noise processor 70 result in coding difficulties, especially when such sinusoidal components are included within a frequency range of 5.5 to 11 kHz in which human hearing is still very sensitive. These difficulties arise because the noise processor 70 does not have sufficient modelling power to accurately represent tonal components in the SSC residual r(n). The present invention is concerned with a problem of determining a perceptually adequate noise representation of when the SSC residual signal includes these high-frequency sinusoidal components.

Referring now to FIG. 2, there is shown the noise processor 70 operable to perform first and second processing operations denoted by SE 100 and TE 110 respectively. The first processing operation SE 100 concerns computation of a spectral envelope and generation of a new whitened signal R. Moreover, the second processing operation TE concerns computational estimating a temporal envelope of the signal R. Corresponding spectral and temporal parameters Pₛ and Pₜ respectively are output from the coder 10 as described in the foregoing, these parameters Pₛ, Pₜ being useable in a subsequent decoder for use thereat in spectrally and temporally shaping locally-generated white noise.

In the noise processor 70, an estimation of the spectral envelope is achieved by applying linear prediction which captures the spectral envelope of the signal s(n) in the form of prediction coefficients. Such linear prediction is, in practice, relatively coarse. In practice therefore, whenever there are clear tonal components in the input signal s(n), the noise processor 70 will tend to represent these tones by parametrically specifying lobes which are wider than necessary for use in representing the signal s(n). For example, in FIG. 3 there is shown a graph comprising an abscissa axis 200 representing frequency bins with associated frequencies increasing from left to right and an ordinate axis 210 denoting amplitude in decibels (dB). An estimated spectral envelope determined by the coder 10 is denoted by 220 whereas the actual amplitude spectrum is denoted by 230. The graph of FIG. 3 presents a lobe at a bin no. 410. A corresponding wide lobe in an envelope centred around the bin no. 410 is considerably wider than required to parametrically represent a clear tonal component around the bin no. 410. Such widening arises because the noise processor 70 utilizes a coarse spectral model. Subsequently, a decoder reconstituting the signal x(n) will generate noise corresponding to the wide lobe resulting in the perception of excessive noise at the decoder, thereby not faithfully regenerating the signal x(n) thereat. By extrapolation, more excess noise is generated at the decoder as more tonal components are included in the residual signal. B2.

The inventors have appreciated that a potential solution to this problem of excessive noise generated at the subsequent decoder is to include a sinusoidal dumping stage in the coder 10 prior to the noise processor 70. Such a sinusoidal dumping stage is operable to extract sinusoidal components from the SSC residual signal B2 with an aim of easing processing performed by the noise processor 70. In this respect, the inventors have surprisingly identified that discarding these tonal components and modelling accurately residual components is susceptible to rendering the coder 10 capable of processing higher quality audio signals; such discarding is found to be better than trying to model them with noise as conventionally done. However, such a solution requires the inclusion of a new processing element in the coder 10 with associated computational complexity. Again, surprisingly, the inventors have identified that a method of coding can be applied that attains a similar result to aforementioned sinusoidal component dumping and which is more susceptible to being applied to combined SSC-RPE coders having a generally lower degree of computational complexity.

In the context of the coder 10 illustrated in FIG. 1, the present invention is concerned with prominent tonal components present in the SSC residual B2 which are coarsely captured by prediction coefficients whose parameters are then subject to spectral broadening to smear out spectral peaks. By using such an approach, the aforementioned problem caused by tonal components in the SSC residual signal B2 can be greatly reduced. When such a modification of spectral broadening of the residual signal B2 applied for the signal represented earlier in FIG. 3, a result as presented in FIG. 4 is achievable. In FIG. 4, there is shown a graph including an abscissa axis 300 corresponding to frequency bins with frequency increasing from left to right, and an ordinate axis 310 spectral component amplitude increasing from bottom to top. A curve 320 is included to represent an estimated spectral envelope as in FIG. 3, whereas a curve 330 is included to represent an estimated spectral envelope as generated by the coder 10 when provided with spectral broadening using a spectral broadening factor of 0.945. It is to be observed in FIG. 4 that spectral broadening has noticeably smeared out a peak in the curve 320 at a frequency bin no. 410. Such smearing results in frequency peaks being less accurately modelled but also provides a benefit of reduced noise at a subsequent decoder. A reduction in noise at the decoder is subjectively preferable with regard to audio signals, for example music signals, at an expense of reduced accuracy when regenerating signals corresponding to frequency peaks at the decoder.

When implementing the present invention by suitably adapting the coder 10, the inventors have found it beneficial to apply aforementioned spectral broadening on a per-excerpt basis; namely, a given broadening factor can be found which, for a given associated excerpt, renders an audio quality at a subsequent decoder superior to that which can be achieved from a contemporary MPEG-4 SSC coder; in such a comparison, both the coder 10 appropriately modified and the MPEG-4 SSC coder operate at an output bit-rate of 24 kbytes/second. Moreover, the inventors have found for audio signals such as music that some excerpts require considerable spectral broadening whereas other excerpts ought not to require such broadening in order to provide a subjectively enhanced result in comparison to MPEG-4 SSC. Although such an approach provides a subjective improvement, there are also drawbacks:

(a) tuning encoder parameters on a per excerpt basis is a computationally tedious process; and
(b) use of a fixed spectral broadening factor per excerpt is not optimal because audio signals are dynamically changing implying that certain parts will contain significant tonal components whereas others will not.

The inventors have therefore further evolved the coder 10 to utilize a method of automatically adjusting the aforementioned spectral broadening factor which is capable of operating on a frame-by-frame basis. Thus, the method is able to set an adequate spectral broadening factor for each frame applied to the signal B2 individually. The method is operable to select a spectral broadening factor on a frame-by-frame basis in response to:

(i) presence of tonal components in a band to be noise coded by the noise processor 70; and
(ii) overall spectral shape of the signal B2.
Optionally, the method employs an algorithm utilizing a strategy as depicted in Table 1:

TABLE 1

| | Tonal components present in the frequency band to | | |
|---|---|---|---|
| | be noise coded in the noise processor 70: | | |
| | | Few: | Many: |
| Overall | Decaying component | Slight spectral | Mild spectral |
| spectral | amplitude with | broadening | broadening |
| shape: | increasing frequency | | |
| | Ascending component | Mild spectral | Severe spectral |
| | amplitude with | broadening | broadening |
| | increasing frequency | | |

Thus, when a frame of the signal B2 includes a high number of tonal components and/or its spectral representation (PSD) (for example, amplitude spectrum or power spectral density) increases with frequency, namely ascending, a spectral broadening that would normally be expected to optimal on a frame-by-frame basis is subjected to perturbation pursuant to Table 1 to increase the degree of spectral broadening applied.

An embodiment of the present invention will now be described with reference to FIG. 5. In FIG. 5, there is shown a coder indicated generally by 400. The encoder 400 is similar to the coder 10 of FIG. 1 except that an extra unit 410 is included wherein the spectral broadening measure (SBM) is determined. This measure (SBM) is susceptible to being used in a noise processor 470 to adapt the spectral envelope or it can be included in the bit-stream. In FIG. 5, bands B1, B2 address first and second frequency ranges; the first frequency range is kHz to 5.5 kHz, whereas the second frequency range is 5.5 kHz to 22 kHz. If required, the noise processor 470 and the spectral broadening unit 410 can be implemented as a single entity, for example by way of modified software when the coders 10, 400 are implemented by way of software executable on computing hardware. Signal output from the filter 60 at the output B2 are processed in the coder 400 in a frame-by-frame basis as described in the foregoing; such processing employed in the coder 400 determines power spectral density (PSD) of the B2 signal and thereby estimates the presence or absence of tonal components therein. A local maximum in the PSD is identified in the unit 410 to be a tonal component if it exceeds associated neighbouring components thereto within a certain Bark range K_{B} by a predetermined threshold. The threshold is preferably in a range of 5 to 15 dB, more preferably 7 dB.

An implementation of the noise processor 470 is depicted in FIG. 6 and is an adaptation of the unit 70 illustrated in FIG. 2; the noise processor 470 is operable to use spectral broadening measure (SBM) generated by the extra unit 410. A power spectral density (PSD) determined in the unit 410 is subdivided into four frequency sub-bands FB₁ to FB₄ as elucidated in Table 2.

TABLE 2

| | |
|---|---|
| Frequency band FB₁ | 0 kHz to 5.5 kHz (namely band B1) |
| Frequency band FB₂ | 5.5 kHz to 11 kHz (lower part of band B2) |
| Frequency band FB₃ | 11 kHz to 16.5 kHz (middle part of band B2) |
| Frequency band FB₄ | 16.5 kHz to 22 kHz (upper parts of band B2) |

Signal content in the frequency band FB₁, corresponding to B1, is substantially negligible on account of operation of the filter 60. In practice, the frequency band FB₄ has been found to be substantially devoid of perceptually relevant tonal components. However, spectral content of the second frequency band FB₂ is most important as it is a psycho-acoustically most relevant band to be modelled using noise. The inventors have found that spectral information, namely PSD, of this second frequency band FB2 is used in the extra unit 410 for determining an adequate degree of spectral broadening to employ when generating the bit-stream.

In practice, the inventors have identified a “rule of thumb” approach where if there are less than three tonal components found in the second frequency band FB₂ by applying the aforesaid tonal component detection rule utilising the aforementioned Bark scale, a low spectral broadening factor is preferably employed, namely a spectral broadening factor of 0.992 is utilized corresponding to almost no spectral broadening. Conversely, if three or more tonal components are identified in the second frequency band FB₂, a more severe spectral broadening is applied, namely a spectral broadening factor of 0.945 is utilized corresponding to considerable spectral broadening. It is to be noted that the quoted bandwidths and γ values are possible settings for a sampling rate of 44.1 kHz; for other sampling rates, other values may be more appropriate.

The spectral broadening applied is also preferably made dependent upon the overall shape of the PSD. For example, the inventors have appreciated that more excess noise problems are experienced in subsequent decoders decoding an output bit-stream form the coder 400 when signals processed in the unit 410 have a PSD whose component amplitude increases with increasing frequency. Consequently, it is preferably that the unit 410 in combination with the noise processor 70 of the coder 400 applies an even harsher spectral broadening, for example by setting the spectral broadening factor to 0.92, when it is found that the mean of the PSD for the third frequency band FB₃ is larger than the mean of the PSD for the second frequency band FB₂.

In FIG. 7, there is shown an illustration of the coder 400 applying spectral broadening as described in the foregoing with reference to Table 2. The illustration concerns a graph including an abscissa axis 500 denoting time and expressed in terms of frame number in ascending order from left to right. The graph further includes an ordinate axis 510 denoting spectral broadening factor wherein a spectral broadening factor of 1 corresponds to substantially no spectral broadening, whereas a spectral broadening factor of 0.92 corresponds to considerable spectral broadening. The curves 520, 530 corresponding to coding within the coder 400 of an excerpt of music performed by Suzanne Vega and; Orchestra respectively. The curve 520 corresponds to Suzanne Vega's voice, whereas the curve 530 corresponds to the Orchestra. The curve 520 has its spectral broadening factor mostly set at its highest level of 0.992, whereas the curve 530 is frequency adjusted to assume a spectral broadening factor value of 0.945. The curve 520 is different to the curve 530 because speech/singing rarely contains high frequency components whereas musical instruments often generate a complex series of overtones/harmonics, for example trumpets and violins. Were it not for the coder 400 applying spectral broadening according to the present invention when processing the excerpt, excessive noise would be encountered in a subsequent decoder.

It will be appreciated that embodiments of the invention described in the foregoing are susceptible to being modified without departing from the scope of the invention as defined by the accompanying claims.

The coder 400 in combination with an associated compatible decoder can be arranged in layers where successive information layers are generated to progressively increase quality and corresponding bit-rate. In such an implementation, original prediction coefficients and spectral broadening factor associated with each layer are included within the bit-stream. In consequence, a most appropriate set of spectral coefficients for regenerating the signal s(n) can be computed at the decoder using the original set of prediction coefficients and the spectral broadening factor information associated with the highest layer when highest decoding quality is to be achieved.

The coder 400 adapted according to the invention is capable of being used in high fidelity audio equipment for encoding music. Moreover, the coder 400 is susceptible to being used in conjunction with video programme content. Furthermore, the coder 400 is susceptible to being used in telecommunication systems as well as electronic consumer products such a televisions, personal computers and electronic books.

In the accompanying claims, numerals and other symbols included within brackets are included to assist understanding of the claims and are not intended to limit the scope of the claims in any way.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

1-17. (canceled)

18. A method of encoding a signal (s(n)) in a coder (400) to generate a corresponding encoded bit-stream, said method comprising steps of:
(a) processing the signal (s(n)) to determine main sinusoidal components and transient components thereof to generate corresponding component parameters (SiP, TrP);
(b) processing the signal (s(n)) by removing the determined sinusoidal and transient components therefrom to generate a residual signal (r(n));
(c) processing the residual signal (r(n)) to determine a spectral representation (PSD) and computing a measure of spectral broadening present in the in the spectral representation (PSD);
(d) determining from the residual signal (r(n)) spectral envelope parameters by linear prediction; and
(e) combining the component parameters (SiP, TrP) together with the spectral envelope parameters and the spectral broadening measure to generate the encoded bit-stream.

19. A method as claimed in claim 18, wherein the spectral broadening measure (SBM) determined in step (c) is operable to at least reduce excess noise that would otherwise arise if the spectral broadening measure were not included in the encoded bit-stream.

20. A method as claimed in claim 18, wherein the spectral broadening measure is determined from the residual signal (r(n)) on a frame-by-frame basis.

21. A method as claimed in claim 20, wherein the spectral broadening measure (SBM) is determined in response to how many prominent tones are identified in the residual signal (r(n)).

22. A method as claimed in claim 21, wherein relatively mild spectral broadening having a factor of substantially 0.992 is applied when the number of prominent tones identified in the residual signal (r(n)) is less than a predetermined threshold, and relatively severe spectral broadening having a factor of substantially 0.945 is applied when the number of prominent tones identified in the residual signal (r(n)) is equal to or greater than said predetermined threshold.

23. A method as claimed in claim 22, wherein the predetermined threshold corresponds to three prominent tones.

24. A method as claimed in claim 20, wherein said one or more prominent tones are determined by applying a Bark scale.

25. A method as claimed in claim 24, wherein the Bark scale is applied to identify a prominent tone when its power spectral density component has an amplitude exceeding those within a neighbourhood thereto by more than a threshold.

26. A method as claimed in claim 25, wherein said threshold is in a range of 5 to 15 dB.

27. A method as claimed in claim 18, said method further comprising steps of filtering the residual signal (r(n)) into a plurality of frequency bands, and determining said spectral broadening measure (SBM) in response to relative mean spectral power density of said plurality of frequency bands.

28. A method as claimed in claim 27, wherein the spectral broadening measure corresponds to no or very little spectral broadening in response to the relative mean spectral power density of said plurality of frequency bands decaying with increasing frequency.

29. A method as claimed in claim 27, wherein the spectral broadening measure in step (c) approaches a value that corresponds to increased spectral broadening in response to the relative mean spectral power density of said plurality of frequency bands increasing with increasing frequency.

30. A coder for encoding an input signal (s(n)) to generate a corresponding encoded bit-stream, said coder being operable according to a method as claimed in claim 18 where the bit-stream includes the spectral broadening measure (SBM) explicitly.

31. A signal processing system comprising:
(a) a coder as claimed in claim 30 for coding an input signal (s(n)) to generate a corresponding encoded bit-stream; and
(b) a decoder for receiving the encoded bit-stream and decoding said bit-stream to regenerate a representation of said input signal (s(n)).

32. Encoded data comprising an encoded bit-stream generated according to a method as claimed in claim 18, said data explicitly including an associated spectral broadening measure (SBM).

33. Encoded data as claimed in claim 32 recorded on a data carrier.
